(19) United States
(12) Patent Application Publication
(10) Pub. No.: US 2006/0015197 A1
(43) Pub. Date: Jan. 19, 2006

(54) Apparatus including audio codec and methods of operation therefor

(76) Inventor: Vivek G. Gupta, Portland, OR (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/881,716

(22) Filed: Jun. 30, 2004

(51) Int. Cl. G06F 17/00

(52) U.S. Cl. 700/94

(57) ABSTRACT

In an embodiment, an electronic device includes one or more audio codec nodes and one or more audio application nodes, which communicate audio information with each other over a communications bus. The communications bus is a packet-based bus, in an embodiment. Power is selectively controlled to selected ones of the audio codec node and the audio application nodes, based on whether or not a node is of use at a particular time.

### TECHNICAL FIELD

The inventive subject matter pertains to apparatus that include audio-processing capabilities, and more particularly, to portable devices that include multiple audio applications that utilize an audio codec, and to methods of operation for such apparatus and devices.

### BACKGROUND

Rising consumer expectations have driven electronics manufacturers to produce portable consumer devices with an ever-increasing variety of features and capabilities. Some of the features being incorporated into consumer electronics include audio applications.

In order to provide a variety of audio applications, a device is likely to include multiple audio-processing subsystems, where each subsystem may support one or more audio-related technologies. For example, a “smart phone” may include a first subsystem to support voice calls over a wireless network, a second subsystem to mix multiple audio streams, and a third subsystem to provide simultaneous audio recording and playback.

As portable device capabilities increase, the portable device's potential power consumption also increases. Because most portable devices are battery-powered, an increase in power consumption means a decrease in the amount of use time between battery charges. Accordingly, along with the drive toward increasing device functionalities, electronics manufacturers strive to develop more conservative ways of consuming the battery power available to portable devices.

### BRIEF DESCRIPTION OF THE DRAWINGS

The appended claims point out different embodiments of the inventive subject matter with particularity. However, the detailed description presents a more complete understanding of the inventive subject matter when considered in connection with the figures, wherein like-reference numbers refer to similar items throughout the figures and:

FIG. 1 is a simplified, conceptual diagram of a wireless communication system, in accordance with an embodiment of the inventive subject matter;

FIG. 2 is a simplified block diagram of an electronic device, in accordance with an embodiment of the inventive subject matter;

FIG. 3 is a simplified block diagram of an audio application subsystem node, in accordance with an embodiment of the inventive subject matter;

FIG. 4 is a simplified block diagram of an audio codec node, in accordance with an embodiment of the inventive subject matter; and

FIG. 5 is a flowchart of a method for implementing power-management within an electronic device that includes an audio codec, in accordance with, an embodiment of the inventive subject matter.

### DETAILED DESCRIPTION

In the following description of various embodiments, reference is made to the accompanying drawings, which form a part hereof and show, by way of illustration, specific embodiments in which the inventive subject matter may be practiced. Various embodiments are described in sufficient detail to enable those skilled in the art to practice the inventive subject matter. It is to be understood that other embodiments may be utilized, and that process or mechanical changes may be made, without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. It will be recognized that the methods of various embodiments can be combined in practice, either concurrently or in succession. Various permutations and combinations will be readily apparent to those skilled in the art.

Embodiments of the inventive subject matter may be implemented in a number of different types of systems and electronic devices. Various embodiments may be implemented in a portable, wireless communications device, in which one or more audio applications may be executed within the device to provide for wireless communication of audio information, among other things. Such embodiments are described in detail, below. Other embodiments may be implemented in stationary communications devices that communicate over wired or wireless links (e.g., stationary telephones, computing devices, radios, televisions, and the like). Such devices may be battery-powered or may receive their power from a connection into an electricity system (e.g., an outlet) or from some other renewable or non-renewable electricity source. Still other embodiments may be implemented in portable or stationary electronic devices that do not communicate audio information over wireless links. For example, but not by way of limitation, embodiments may be implemented in a recording system that recognizes speech and converts the speech to text, while simultaneously performing some other audio application.

An electronic device in which an embodiment is implemented may operate as a stand-alone entity, at a given time, or may communicate with elements of a larger system. For example, but not by way of limitation, embodiments may be implemented in a portable communications device of a wireless local area network (WLAN), a wireless wide area network (WWAN), a Bluetooth communications environment, a wireless personal area network (WPAN), a wireless metropolitan area network (WMAN), a cellular communications system, a satellite communications system, a radio network, a computer network, or another type of wired or wireless network.

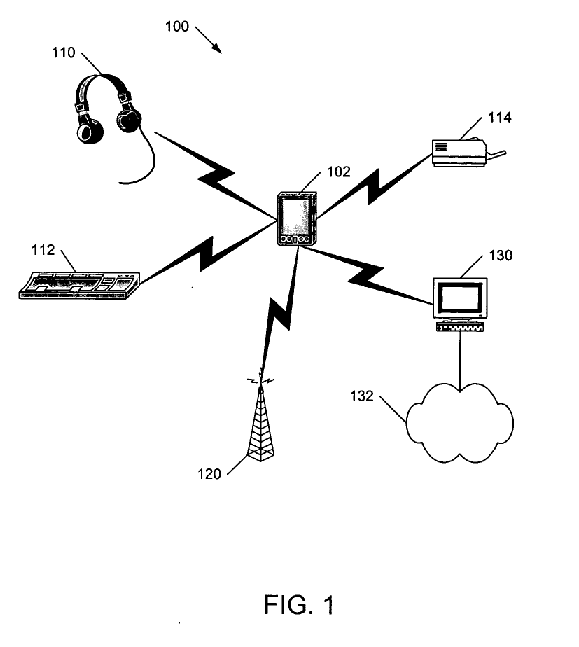

FIG. 1 illustrates an example environment in order to illustrate various embodiments. The example is not meant to limit the scope of the inventive subject matter to application within such an environment. Instead, as would be obvious to one of skill in the art based on the description herein, embodiments may be implemented in a number of different types of portable or stationary devices, which include multiple audio applications. Additionally, embodiments may be implemented in a variety of different types of systems.

FIG. 1 is a simplified, conceptual diagram of a wireless communication system 100, in accordance with an embodiment of the inventive subject matter. System 100 may include from one to many stationary and/or portable electronic devices, such as portable electronic device 102. The term “electronic device” is meant to include both portable and stationary devices.

A “portable” electronic device is defined herein as a device that may be readily carried or transported by a person. For example, but not by way of limitation, a portable electronic device may include a laptop computer, a portable telephone, a personal data assistant, a pager, an audio recording and/or playback device, a radio, a network adaptor (e.g., a network interface card), a combination of these devices, and/or other devices. A portable electronic device may use batteries as a source of power, and/or it may receive power from some other source.

A “stationary” electronic device is defined herein as a device that may not be readily carried by a person. For example, but not by way of limitation, a stationary electronic device may include a desktop or server computer, a hardwired telephone, and/or other devices, including devices that are transported on a vehicle. A stationary electronic device may receive power from a standard electrical connection to an electrical power system (e.g., a power grid), and/or it may use batteries as a source of power, and/or it may receive power from some other source.

An electronic device (e.g., portable device 102), according to various embodiments, may include multiple audio applications, where an “audio application” is an application that consumes, transfers, formats, processes, and/or produces audio information. “Audio information” is used herein to mean digitized information representing voice, music, and other audible sounds. For example, audio information may include sampled and digitized voice, music, and/or other audible sounds. Audio information may be compressed or uncompressed, or encoded or unencoded, in various embodiments. The term “audio signal” is used herein to mean an analog signal representing voice, music, and other audible sounds.

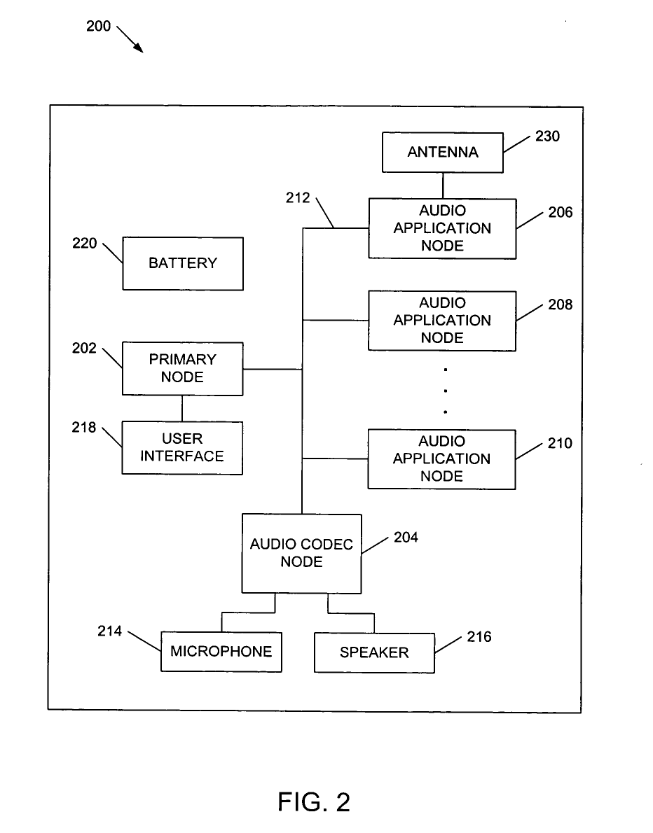

One or more audio applications may be executed within a “node” of a device, as will be described in more detail in conjunction with FIG. 2. Execution of some types of audio applications may result in the transmission or reception of information outside of the device 102 over the medium of free space, commonly referred to as the “air interface.” Execution of other types of audio applications may result in the transmission or reception of information over wired connections to the device 102. Execution of still other types of audio applications may not result in the transmission or reception of information outside of the device 102.

In FIG. 1, several examples are illustrated of wireless interactions with devices that are distinct from the device 102. For example, but not by way of limitation, device 102 may communicate using a Bluetooth or other similar-purpose protocol with a wireless headset 110, wireless keyboard 112, a printer 114, or many other types of devices. Alternatively or in addition, device 102 may communicate using a cellular or other radio protocol with an antenna 120 of a base station, access point or other infrastructure element of a communication system. Alternatively or in addition, device 102 may communicate using an Institute of Electrical and Electronics Engineers (IEEE) 802.11 and/or 802.15 standard protocol with a computer 130 and/or network 132. In other embodiments, device 102 may communicate with other wireless-capable devices using different wireless communication protocols. Further, although only wireless examples are illustrated in FIG. 1, device 102 may also or alternatively communicate over wired links with other computers, speakers, microphones, devices, and/or system elements, in other embodiments.

As mentioned previously, embodiments may be implemented in any of a variety of electronic devices. For example, but not by way of limitation, embodiments may be implemented in a stationary, portable or laptop computer, a WLAN device, a WWAN device, a WPAN device, a WMAN device, a cellular telephone, a portable telephone, a hardwired telephone, a radio, a pager, a personal data assistant, a global positioning system (GPS) device, a satellite transmitter and receiver, an access point, a base station, an audio recording and/or playback device, a radio, a network adaptor (e.g., a network interface card), a combination of these devices, and/or other devices.

FIG. 2 is a simplified block diagram of an electronic device 200, in accordance with an embodiment of the inventive subject matter. In an embodiment, electronic device 200 includes a primary node 202, an audio codec node 204, and at least one audio application node 206, 208, 210. Embodiments of a primary node 202, audio codec node 204, and audio application node 206, 208, 210 are described in detail below. Although three audio application nodes 206, 208, 210 are illustrated in FIG. 1, more or fewer audio application nodes may be present in a device, in other embodiments. Further, a primary node 202, audio codec node 204, and/or audio application node 206, 208, 210 may have other radios, peripherals, and/or other devices coupled to them.

The term “node,” as used herein, means a hardware element (e.g., a device, circuit, subsystem, and/or chipset) that is independently coupled to a hardwired, inter-node communication mechanism (e.g., bus 212) resident within the device. In an embodiment, a “node” is an end point, which receives and/or produces packets of information that are communicated over a packet-based communications bus. Each node may have a “peer-to-peer” connection with other nodes through the communications bus.

As will be described in more detail later, a device's audio codec is included in a distinct audio codec node 204, which is operatively coupled to other nodes through a communications bus or link. Accordingly, the audio codec may be operated and powered independently from audio applications and/or other functions performed by other nodes (e.g., nodes 202, 206, 208, 210). When the audio codec, within audio codec node 204, is “of use” or “useful” to one or more audio applications, audio codec node 204 may be “powered-up” to a first operational power level, if it is not already in that power state. When the audio codec is “not of use” or “un-useful” to one or more audio applications, audio codec node 204 may be “powered-down,” meaning that the audio codec node may be powered at a second power level, which is lower than the first operational power level, if the node is not already in the lower power state. This enables a device to use power in a more conservative manner, as the audio codec node may be at a power level that is less than an operational power level when the audio codec node is not in use. Further, in an embodiment, the primary node 202 and/or one or more other audio application nodes 206, 208, 210 may be selectively “powered up” and “powered down” when they are “of use” and “not of use,” respectively. This further enables a device to conserve power.

An “operational power level” may be different for any or all of the audio codec node, the primary node, and/or any of the audio application nodes. Similarly, a “lower power level” may be different for any of all of the nodes. In some cases, the lower power level may be a level at which the node is no longer operable, and at which information in volatile memory, if any, is lost. In other cases, the lower power level may be a level at which the node may not be operable, but at which volatile memory information is retained. In still other cases, the lower power level may be a level that still enables the node to perform some functions, although they may not perform as quickly or efficiently. This may enable the node to be powered up more quickly and easily than if the node's power level were reduced to a sub-operational level.

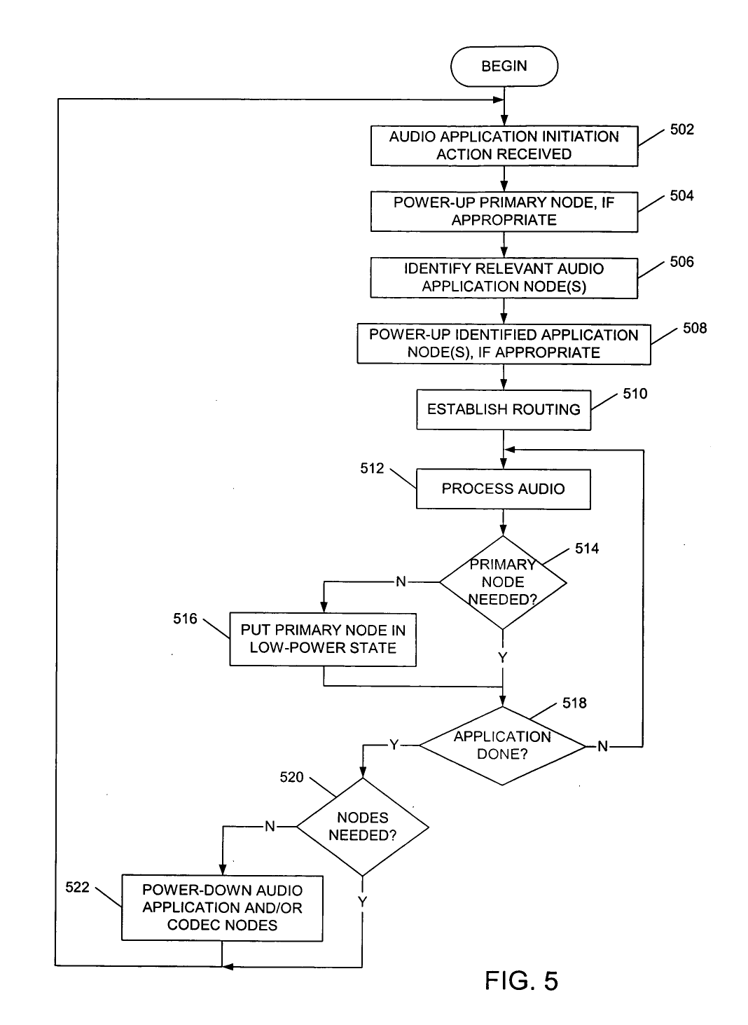

In an embodiment, primary node 202 controls power-up and power-down of audio codec node 204, primary node 202, and/or one or more audio application nodes 206, 208, 210, although these tasks may be performed by other nodes or device elements, in other embodiments. Power-up and power-down of audio codec node 204 and other nodes 202, 206, 208, 210 is described in more detail later in conjunction with FIG. 5.

In an embodiment, nodes 202, 204, 206, 208, 210 are operatively coupled together through communications bus 212. In an embodiment, communications bus 212 is a packet-based communications bus, which may be scalable to allow a variable number of nodes to be coupled to the communications bus. In other embodiments, nodes 202, 204, 206, 208, 210 may be operatively interconnected through a different kind of peer-to-peer, mesh, or other type of bus or interconnection, and/or nodes 202, 204, 206, 208, 210 may be operatively interconnected through multiple busses. Nodes 202, 204, 206, 208, 210 communicate audio information between each other over bus 212. In addition, nodes 202, 204, 206, 208, 210 may communicate control messages and/or other types of information over bus 212.

In an embodiment, primary node 202 includes all or a portion of an application subsystem, which includes one or more application processors. Primary node 202 may perform some or all of the following tasks, in various embodiments:
execution of some or all of the device's core operation system;
execution of one or more audio and/or other applications (e.g., mixing audio packets, recording on a local storage medium, etc.);
controlling execution of one or more audio applications by other nodes (i.e., “launching” audio applications within other nodes);
interpreting user interface inputs and/or causing the user interface to produce particular user interface outputs;
establishing audio information routing between one or more audio application nodes 202, 206, 208, 210 and the audio codec node 204; and/or
monitoring and/or controlling application of power to selected ones of the nodes 202, 204, 206, 208, 210.

In alternate embodiments, some or all of these tasks may be performed by one or more other nodes. Primary node 202 may be considered as an “audio application node,” if it executes one or more audio applications.

Primary node 202 and selected ones of the audio application nodes 206, 208, 210 may include one or more processors or processing elements, one or more bus interfaces, one or more peripheral or other interfaces, one or more wireless communications input or output stages, one or more antennas, one or more types of volatile or non-volatile data storage mechanisms, one or more logic units or elements, and/or one or more power control elements, among other things.

Primary node 202 may be capable of executing one or more audio applications. In addition, each audio application node 206, 208, 210 may be capable of executing one or more audio applications. For example, but not by way of limitation, a node may be capable of executing one or more audio applications selected from a group of applications that includes a cellular telephone application, a WLAN application, a WWAN application, a Bluetooth communications application, a WPAN application, a WMAN application, an audio recording application, an audio playback application, a voice encoding application, a voice decoding application, a speech recognition application, a speech-to-text conversion application, a text-to-speech conversion application, a Voice over Internet Protocol (VOIP) application, and a wireless radio application. A device may be capable of executing one or more other types of audio applications in addition or alternatively.

For example, but not by way of limitation, audio application node 206 may be capable of executing a WLAN application. In such an embodiment, audio application node 206 may include hardware and software that are capable of receiving WLAN-destined audio information from bus 212, and processing and preparing the audio information for transmission to a WLAN over an antenna 230. Audio application node 206 may also include hardware and software that are capable of receiving WLAN-originated signals from antenna 230, and processing and preparing digital information derived from the signals to be sent over the bus 212 to the audio codec node 204 or to another node.

At any given time, a device may not be executing any audio applications, or the device may be executing a single audio application, or the device may simultaneously be executing multiple audio applications. For example, but not by way of limitation, a device may be implementing any one of the following scenarios (or another scenario):
the device is supporting a single wireless telephone call;
the device is supporting a wireless telephone call at the same time that the device is outputting a locally-stored Moving Picture Experts Group Audio Layer 3 (MP-3) file to the device's speaker (the device may mix the MP-3 information into the outgoing call stream so that the remote user may hear the music, as well); or
the device may output a MP-3 file while simultaneously recording the file to a local storage medium.
   Numerous other combinations of audio applications may be executed, as would be apparent to one of skill in the art, based on the description herein.

Other audio application nodes 208, 210 may be coupled to or include one or more antennas. Antenna 230 and other antennas may include any of a number of types of antennas, including but not limited to one or more of a patch, omnidirectional, beam, monopole, dipole, multiple-in/multiple-out (MIMO), and rhombic antenna, among others.

As described previously, audio codec node 204 is operatively coupled to bus 212, in an embodiment. Audio codec node 204 serves as an interface between analog audio signals and digital audio information. In an embodiment, audio codec node 204 receives analog audio signals from a microphone 214, digitizes the analog audio signals, and prepares the digital audio information to be sent over communications bus 212 to one or more audio application nodes. Audio codec node 204 also may receive digital audio information from one or more audio application nodes over the communications bus 212, convert the digital audio information to analog audio signals, and send the analog audio signals to a speaker 216.

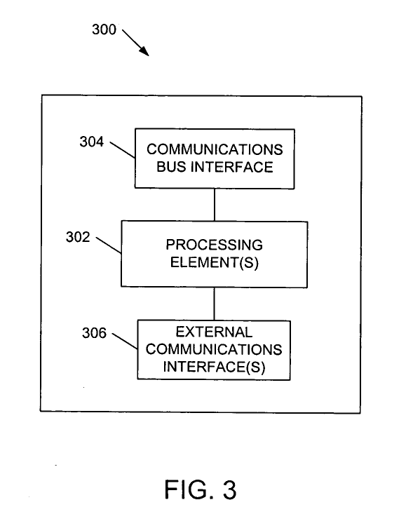

Audio codec node 204 encodes and decodes audio information. In alternate embodiments, audio codec node 204 may either encode or decode audio information, but not both. In still another alternate embodiment, a first audio codec node may be dedicated to encoding audio information, and a second audio codec may be dedicated to decoding audio information. An embodiment of an audio codec node is described later in conjunction with FIG. 3.

Electronic device 200 may include a variety of interfaces that enable device 200 to interact with the external environment. For example, but not by way of limitation, electronic device 200 may include a microphone 214, a speaker 216, and/or a user interface 218. In an embodiment, microphone 214 and speaker 216 are operatively coupled to audio codec node 204. In another embodiment, one or more intervening device elements (e.g., filters, buffers, pre-processors) may be present between audio codec node 204 and microphone 214 and/or speaker 216.

User interface 218 may include, for example, a display screen, a keypad, a pointing device, and/or one or more other mechanisms to enable a user to input information or commands into device 200 and/or to perceive information from device 200. In an embodiment, user interface 218 is operatively coupled to primary node 202. In such an embodiment, primary node 202 may interpret user inputs received from user interface 218, and it may initiate action within the device, based on the user inputs. Primary node 202 also may receive audio or other information from other nodes (e.g., nodes 204, 206, 208, 210), and it may provide information to user interface 218 that causes user interface 218 to produce perceptible outputs. In other embodiments, user interface inputs and/or outputs may be interpreted or controlled by one or more other nodes.

In an embodiment, electronic device 200 is operationally powered by a limited power source, such as, for example, a set of one or more batteries 220, solar cells, fuel cells, or other limited power source. In another embodiment, electronic device 200 may receive power from an unlimited power source, such as, for example, an electrical connection to an electrical outlet and power grid infrastructure.

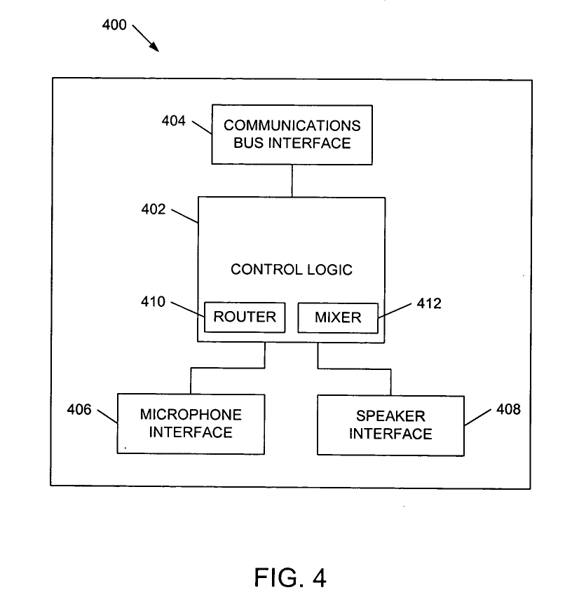

FIGS. 3 and 4 illustrate embodiments of an audio application node (e.g., nodes 202, 206, 208, 210) and an audio codec node (e.g., node 204), respectively. Both of the illustrated embodiments are for example purposes, and it would be apparent to one of skill in the art, based on the description herein, that each node may have different configurations from those illustrated.

FIG. 3 is a simplified block diagram of an audio application subsystem node 300, in accordance with an embodiment of the inventive subject matter. The functional blocks illustrated in audio application node 300 may be included, for example, within primary node 202 and/or audio application nodes 206, 208, 210. Audio application node 300 includes one or more processing elements 302 and a communications bus interface 304. In embodiments where audio application node 300 communicates outside of the device, audio application node 300 also includes one or more external communications interfaces 306.

The one or more processing elements 302 may include one or more general-purpose or special-purpose processors, one or more logic blocks, and/or one or more other processing elements. In an embodiment, one or more processing elements 302 may execute one or more audio applications. Instructions or code relating to the audio application may be resident within the audio application node (e.g., in volatile or non-volatile storage) and loaded into the one or more processing elements for execution. Alternatively, the instructions or code may be retrieved from a storage location external to the audio application node 300.

Communications bus interface 304 may be a one-way or two-way interface with a communications bus (e.g., bus 212, FIG. 2) over which audio information is communicated. A two-way interface may include a first buffer to queue first audio information packets received from an audio codec node or another node over the communications bus. Received packets may be processed or otherwise consumed by an audio application executed by processor element 302. The two-way interface may also include a second buffer to queue second audio information packets produced by processor element 302 for transmission over the communications bus to an audio codec node or another node.

In embodiments where audio application node 300 communicates outside of the device, external communications interface 306 enables audio information and/or signals to be transmitted. In an embodiment, interface 306 includes one or more antenna interfaces and/or one or more antennas, which enable the device to communicate in a wireless manner (e.g., cellular, radio, infrared or other). In another embodiment, interface 306 includes one or more interfaces to a hardwired connection to an external device and/or network. For example, but not by way of limitation, interface 306 may include a hardwired connection to the Internet, to a local area network or to another device (e.g., a computer). Audio application node 300 may include other interfaces, data storage capabilities, circuits, and other elements, in various other embodiments.

Selected audio application nodes send audio information to an audio codec node over a communications bus, receive audio information from an audio codec node over the communications bus, or both.

FIG. 4 is a simplified block diagram of an audio codec node 400, in accordance with an embodiment of the inventive subject matter. In an embodiment, audio codec node 400 includes control logic 402, a communications bus interface 404, and either or both a microphone interface 406 and a speaker interface 408.

Audio codec node functionality will be described in two directions: 1) in a first direction from the communications bus to a speaker; and 2) in a second direction from a microphone to the communications bus. It is to be understood that a particular audio codec node may process audio information in one direction or in both directions.

In the first direction, communication bus interface 404 receives one or more first audio information packets over a communications bus (e.g., bus 212, FIG. 2) from one or more audio applications being run in one or more audio application nodes (e.g., nodes 202, 206, 208, 210, FIG. 2). In an embodiment, communications bus interface 404 includes a first buffer to receive and queue the first audio information packets, which may be referred to as “speaker-destined” audio information packets, because they include speaker-destined audio information.

Control logic 402 receives the speaker-destined audio information packets from communication bus interface 404, and it converts the packets into audio information for output by the speaker. In an embodiment, this includes extracting audio information from each packet, and sequencing the audio information, if necessary.

Control logic 402 provides the audio information to speaker interface 408. In an embodiment, speaker interface 408 converts the speaker-destined audio information from digital to analog, and it outputs the speaker-destined audio signal to the speaker.

In the other direction, microphone interface 406 receives microphone-produced analog signals from a microphone, and it converts the signals into digital audio information. Microphone interface 406 provides the microphone-produced audio information to control logic 402.

Control logic 402 packetizes the microphone-produced audio information, resulting in audio information packets, in an embodiment. Control logic 402 provides the microphone-produced audio information packets to communication bus interface 404.

In an embodiment, communications bus interface 404 includes a second buffer to receive and queue the microphone-produced audio information packets, which may be referred to as “second” audio information packets. Communication bus interface 404 sends the one or more second audio information packets over the communications bus (e.g., bus 212, FIG. 2) to one or more audio applications being run in one or more audio application nodes (e.g., nodes 202, 206, 208, 210, FIG. 2).

In an embodiment, audio codec node 400 is capable of mixing multiple audio information streams received over the communications bus for perceived simultaneous output on a speaker. Accordingly, in an embodiment, audio codec node 400 may additionally include a mixer 412, which may be separate from or integrated with control logic 402.

In still another embodiment, audio codec node 400 is capable of separating a combined audio information stream received from the microphone, and routing resulting multiple audio information streams to multiple ones of the audio application nodes. Accordingly, in such an embodiment, audio codec node 400 may additionally include a router 410, which may be separate from or integrated with control logic 402.

The above description indicates the independence of an audio codec node (e.g., audio codec node 204, FIG. 2) within a device. By “independence,” it is meant that the audio codec node may not be directly coupled to any other node, but instead communications and control of the audio codec node may be performed over a bus (e.g., bus 212, FIG. 2). This configuration provides significant advantages over prior methods, as will be further clarified below. One advantage is that a power-management process may be performed in conjunction with an embodiment of a device, which may enable the device to consume less power, within a given time interval. In a device that relies on battery power, this may result in a longer use time available between battery charges. FIG. 5 illustrates an example of a power-management process in accordance with an embodiment.

FIG. 5 is a flowchart of a method for implementing power-management within an electronic device that includes an audio codec, in accordance with an embodiment of the inventive subject matter. The method begins, in block 502, when an action occurs, which indicates that initiation of a new instance of an audio application may be warranted. In an embodiment, the action may be the receipt of a particular user input (e.g., a user presses a “call” or “record” or “playback” button). In another embodiment, the action may be a detection of an attempt to establish audio communications with the device by another external device or network (e.g., receipt of a “request to send” message from a remote radio).

In an embodiment, in block 504, a primary node (e.g., node 202, FIG. 2) is powered-up in response to the action, if appropriate. In an embodiment, a primary node is maintained at a “low-power” level during some or substantially all times when the primary node is not “of use” to support device operations, to control applications executed in other nodes, or to execute applications itself. A “low-power” level is defined herein as a power level that is lower than an operable power level. A determination of whether the primary node, an audio application node, and/or the audio codec node are in a low-power or high-power state at any given time may be made by evaluating a table, which indicates the then-current power state of the nodes, in an embodiment. The power states or levels may be determined in another way, in other embodiments.

In an embodiment, the primary node's responsibilities may include establishing information routing among various nodes of the system. Accordingly, if the primary node is in a low-power state, and the node becomes useful for establishing inter-node routing, the primary node is powered-up, in an embodiment. Power-up includes increasing, to an operational level, the power supplied to the primary node (i.e., the primary node transitions to a “high-power” state). If the primary node already is running at an operational power level when an audio application initiation action occurs, then the process of powering-up the primary node may be bypassed.

In block 506, one or more audio application nodes are identified as nodes that may execute an audio application that is relevant to the application initiation action. In an embodiment, the primary node identifies the nodes that may be of use to execute an audio application. For example, but not by way of limitation, if a user provided a user input to play an MP-3 file stored locally within the device, then the primary node may identify an audio application node that is capable of retrieving and processing MP-3 data. In other embodiments, identification of the relevant nodes may be performed by one or more other nodes or device elements.

In block 508, the identified audio application node is powered-up, along with the audio codec node, if appropriate. As previously indicated, power-up is performed when a node that may be of use is in a low-power state. If the node is already in a high-power state, power-up is not performed.

In an embodiment, the primary node controls power-up of the audio application nodes and/or the audio codec node. Power control may be achieved, for example, by the primary node sending one or more instructions to a power control module within or external from the one or more nodes. Accordingly, the audio codec node and/or the useful application nodes receive power in response to power control inputs provided by the primary node, in an embodiment. In other embodiments, power control of the application nodes and/or the audio codec node may be performed by one or more other nodes or device elements.

In block 510, audio routing between the identified audio application node and the audio codec node is established. In an embodiment, routing is initially established through control instructions, provided by the primary node, to the identified audio application node and/or the audio codec node. In other embodiments, routing may be established by one or more other nodes or device elements.

In block 512, the audio information pertaining to the audio application is processed by the audio codec node and the identified audio application node. At this time, in an embodiment, audio information packets are exchanged between the audio codec node and the identified audio application node over the communications bus (e.g., bus 212, FIG. 2), and the primary node may be essentially “out of the loop.”

In block 514, a determination is made whether the primary node is still of use. The primary node may be considered of use if it is currently supporting device operations, controlling applications executed in other nodes, establishing routing, or executing applications itself. If it is determined that the primary node is no longer of use, then in block 516, the primary node is powered-down, in an embodiment. In an embodiment, the primary node itself may determine if it is still of use, and may initiate power-down if it is not. In other embodiments, one or more other nodes or device elements may determine if the primary node is still of use, and initiate power-down.

In block 518, a determination is made whether an application has completed. In one embodiment, an indication that the application has been terminated may be received. For example, a user may press the “end call” button or a remote caller may hang up. If the application has not completed, the process iterates as shown.

If the application has completed, a determination is made, in block 520, whether the identified audio application node and the audio codec node are still of use in supporting execution of some other ongoing or upcoming application. If not, then the identified audio application node and/or the audio codec node may be powered-down, in block 522, or placed in a low-power state.

In an embodiment, the primary node is powered-up (if it is currently in a low-power state), to control power-down of the identified audio application node and/or the audio codec node. In another embodiment, the identified audio application node or the audio codec node themselves may determine if they are still of use, and may initiate power-down if they are not. In other embodiments, this power control may be performed by another node or device element. The procedure then iterates as shown, again waiting for an action that initiates an audio application, in block 502.

Embodiments described above enable power to be used in a conservative manner by maintaining audio application nodes and/or an audio codec node in a low-power state during some or substantially all portions of time when either or both types of nodes are “of use.” Although power control may be similarly performed for a primary node, one or more audio application nodes, and an audio codec node, in alternate embodiments, power control may be performed for only a subset of these node types.

Embodiments described above also may achieve “bounded latency” within a system. Once communication paths are established between an audio application node and an audio codec node for a given application, variable latencies introduced by software routing routines (e.g., because of processor availability, instruction caching, etc.) may be significantly reduced or eliminated. Instead, the latencies along the path are introduced primarily by hardware elements (e.g., microphone, analog-to-digital converter, filters, etc.). Hardware latencies typically are less variable than software latencies. Accordingly, the total latency of a given path may be less variable through the course of executing an application.

The foregoing description of specific embodiments reveals the general nature of the inventive subject matter sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

The operations described above, with respect to the methods illustrated and described herein, can be performed in a different order from that disclosed. The various procedures described herein can be implemented in hardware, firmware or software. A software implementation can use microcode, assembly language code, or a higher-level language code. The code may be stored on one or more volatile or non-volatile computer-readable media during execution or at other times. These computer-readable media may include hard disks, removable magnetic disks, removable optical disks, magnetic cassettes, flash memory cards, digital video disks, Bernoulli cartridges, random access memories (RAMs), read-only memories (ROMs), and the like. Accordingly, a computer-readable medium, including those listed above, may store program instructions thereon to perform a method, which, when executed within an electronic device, results in embodiments of the inventive subject matter being carried out.

What is claimed is:

1. An apparatus comprising:
a first node, coupled to a communications bus within a portable device, to control application of power to selected ones of an audio codec node and one or more audio application nodes; and
the audio codec node, coupled to the communications bus, to communicate audio information over the communication bus with one or more audio application nodes.

2. The apparatus of claim 1, further comprising:
the one or more audio application nodes, coupled to the communications bus, to execute one or more audio applications.

3. The apparatus of claim 2, wherein the one or more audio application nodes include one or more audio applications selected from a group of applications that includes a cellular telephone application, a wireless local area network application, a wireless wide area network application, a wireless personal area network application, a wireless metropolitan area network, a Bluetooth communications application, an audio recording application, an audio playback application, a voice encoding application, a voice decoding application, a speech recognition application, a speech-to-text conversion application, a text-to-speech conversion application, a voice over Internet protocol application, and a wireless radio application.

4. The apparatus of claim 1, wherein the first node comprises:
a processor to cause power-up of selected ones of the one or more audio application nodes that are determined to be of use, to cause power-down of other selected ones of the one or more audio application nodes that are determined not to be of use.

5. The apparatus of claim 4, wherein the processor is further to cause power-down of a primary node when the primary node is not of use.

6. The apparatus of claim 1, wherein the audio codec node comprises:
a communications bus interface, to receive speaker-destined audio information from the communications bus and to send the speaker-destined audio information to control logic, and to receive microphone-produced audio information from the control logic and to send the microphone-produced audio information over the communications bus; and
the control logic, to prepare the microphone-produced audio information for transmission over the communications bus, and to prepare the speaker-destined audio information for output by a speaker.

7. The apparatus of claim 6, wherein the communications bus interface comprises:
a first buffer to queue first audio information packets received from the communications bus; and
a second buffer to queue second audio information packets for transmission over the communications bus.

8. The apparatus of claim 6, further comprising:
a microphone interface, coupled to the control logic, to receive microphone-produced audio signals from a microphone; and
a speaker interface, coupled to the control logic, to receive the speaker-destined audio information from the control logic.

9. The apparatus of claim 6, wherein the audio codec node further comprises:
a mixer to combine multiple audio information streams received over the communications bus for perceived simultaneous output on a speaker.

10. The apparatus of claim 6, wherein the audio codec node further comprises:
a router to separate a combined audio information stream and to route resulting multiple audio information streams to multiple ones of the audio application nodes.

11. The apparatus of claim 1, further comprising:
the communications bus, wherein the communications bus comprises a packet-based communications bus, which is scalable to allow a variable number of nodes to be coupled to the communications bus.

12. The apparatus of claim 1, further comprising:
a microphone, coupled to the audio codec node.

13. The apparatus of claim 1, further comprising:
a speaker, coupled to the audio codec node.

14. A portable electronic device comprising:
a primary node, coupled to a communications bus, to control application of power to selected ones of an audio codec node and one or more audio application nodes;
the audio codec node, coupled to the communications bus, to communicate audio information over the communication bus with one or more audio application nodes;
the one or more audio application nodes, coupled to the communications bus, to execute one or more audio applications;
the communications bus; and
an antenna, coupled to at least one of the one or more audio application nodes.

15. The portable electronic device of claim 14, further comprising:
a microphone, coupled to the audio codec node; and
a speaker, coupled to the audio codec node.

16. The portable electronic device of claim 14 wherein the one or more audio application nodes include one or more audio applications selected from a group of applications that includes a cellular telephone application, a wireless local area network application, a wireless wide area network application, a wireless personal area network application, a wireless metropolitan area network, a Bluetooth communications application, an audio recording application, an audio playback application, a voice encoding application, a voice decoding application, a speech recognition application, a speech-to-text conversion application, a text-to-speech conversion application, a voice over internet protocol application, and a wireless radio application.

17. The portable electronic device of claim 14 wherein the primary node comprises:
a processor to cause power-up of selected ones of the one or more audio application nodes that are determined to be of use, to cause power-down of other selected ones of the one or more audio application nodes that are determined not to be of use.

18. The portable electronic device of claim 17, wherein the processor further is to cause power-down of the primary node when the primary node is not of use.

19. The portable electronic device of claim 14, wherein selected ones of the one or more audio application nodes comprise:
a processor to cause power-down of the selected ones of the one or more audio application nodes that are determined not to be of use.

20. The portable electronic device of claim 14, wherein the audio codec node comprises:
a communications bus interface to receive speaker-destined audio information from the communications bus and to send the speaker-destined audio information to control logic, and to receive microphone-produced audio information from the control logic and to send the microphone-produced audio information over the communications bus; and
the control logic to prepare the microphone-produced audio information for transmission over the communications bus, and to prepare the speaker-destined audio information for output by a speaker.

21. The portable electronic device of claim 20, wherein the audio codec node comprises:
a mixer to combine multiple audio information streams received over the communications bus for perceived simultaneous output on a speaker.

22. The portable electronic device of claim 20, wherein the audio codec node comprises:
a router to separate a combined audio information stream and to route resulting multiple audio information streams to multiple ones of the audio application nodes.

23. The portable electronic device of claim 14, wherein the communications bus is a packet-based communications bus, which is scalable to allow a variable number of nodes to be coupled to the communications bus.

24. A method comprising:
an audio codec node receiving power in response to power control outputs produced by a first node of a portable device, wherein the audio codec node and the first node are independently coupled to a communications bus of the portable device.

25. The method of claim 24, further comprising:
the audio codec node communicating audio information over the communication bus with one or more audio application nodes.

26. The method of claim 24, further comprising:
the first node causing power-up of selected ones of the one or more audio application nodes that are determined to be of use; and
the first node causing power-down of selected ones of the one or more audio application nodes that are determined not to be of use.

27. The method of claim 24, further comprising:
the audio codec node combining multiple audio information streams received over the communications bus for simultaneous perceived output on a speaker.

28. The method of claim 24, further comprising:
the audio codec node separating a combined audio information stream and routing resulting multiple audio information streams to one or more audio application nodes.

29. A computer-readable medium having program instructions stored thereon to perform a method, which when executed within an electronic device, result in:
an audio codec node receiving power in response to power control outputs produced by a first node of a portable device, wherein the audio codec node and the first node are independently coupled to a communications bus of the portable device; and
the audio codec node communicating audio information over the communication bus with one or more first audio application nodes.

30. The computer-readable medium of claim 29, wherein execution of the method further results in:
the first node causing power-up of selected ones of the one or more audio application nodes that are determined to be of use;
the primary node causing power-down of selected ones of the one or more audio application nodes that are determined not to be of use; and
the primary node establishing audio information routing between the one or more audio application nodes and the audio codec.

31. The computer-readable medium of claim 29, wherein execution of the method further results in:
causing power-down of the primary node when the primary node is not of use.
